(19) United States
(12) Patent Application Publication
(10) Pub. No.: US 2018/0274270 A1
(43) Pub. Date: Sep. 27, 2018

(54) BEZEL-LESS RELEASE BUTTON

(71) Applicant: Ford Global Technologies, LLC, Dearborn, MI (US)

(72) Inventors: Chris Fredriksson, LaSalle (CA); Michael Medoro, Livonia, MI (US)

(73) Assignee: Ford Global Technologies, LLC

(21) Appl. No.: 15/469,682

(22) Filed: Mar. 27, 2017

(51) Int. Cl. E05B 83/28; B60R 7/08

(52) U.S. Cl. CPC E05B 83/28; E05B 83/32; B60R 7/08

(57) ABSTRACT

A bezel-less actuator button is disposed on a seat assembly and is operable between at-rest and actuated positions. The actuator button is coupled to a trim cover that covers a cushion member of the vehicle seat. The actuator button includes a head member and a shaft portion extending outwardly from the head member through a receiving well disposed in the cushion member and opening into a seat interior. A portion of the trim cover is coupled to a receiving channel defined between the head member of the actuator button and a plate member disposed on the shaft portion of the actuator button. The actuator button is retained in place by the trim cover and the cushion member without the need for a separate bezel assembly.

### FIELD OF THE INVENTION

The present invention generally relates to a release button, and more particularly, to a bezel-less release button that is operable between at-rest and actuated positions for moving a lock mechanism between locked and released conditions.

### BACKGROUND OF THE INVENTION

Release buttons are typically designed using an interior translating button in an outside stationary bezel. The outside stationary bezel generally serves as a close-out feature for a soft trim cover. The interface between a translating button and the outside stationary bezel can be a source for vibration or rattle between components, and is also a potential pinch point for a finger of a user actuating the release button. As such, the present concept seeks to provide a bezel-less release button configured to couple to a trim cover without the need for a bezel assembly, thereby eliminating the potential pinch point, potential for vibration and rattle between components, as well as reduce the costs of the overall assembly.

### SUMMARY OF THE INVENTION

One aspect of the present invention includes an actuator button having a head member with first and second surfaces and a shaft portion extending outwardly from the second surface of the head member. A plate member is disposed on the shaft portion and includes inner and outer surfaces. A receiving channel is defined between the second surface of the head member and the outer surface of the plate member.

Embodiments of the first aspect of the invention can include any one or a combination of the following features:
an actuator button having a head member with first and second surfaces and a shaft portion;
a plate member disposed on the shaft portion and having inner and outer surfaces; and
a receiving channel is defined between the second surface of the head member and the outer surface of the plate member.

Another aspect of the present invention includes a vehicle seat having a cushion member with a receiving well disposed therethrough. A trim cover covers the cushion member and has an access aperture aligned with the receiving well of the cushion member. An actuator button is coupled to the trim cover and includes a head member abutting an outer surface of the trim cover and a shaft portion extending into the receiving well of the cushion member.

Yet another aspect of the present invention, includes a vehicle component having a trim article covered by a trim cover and having an access aperture opening into an interior cavity of the vehicle component covered by the trim article. An actuator button includes a head member and a shaft portion extending outwardly from the head member through the receiving well of the trim article into the interior cavity of the vehicle component. A portion of the trim cover is coupled to a receiving channel defined between the head member and a plate member disposed on the shaft portion of the actuator button.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a cross-sectional view of a release button of the prior art;

FIG. 2A is a top perspective view of a release button according to one embodiment of the present invention;

FIG. 2B is a top perspective view of a release button according to another embodiment of the present invention with a head member disconnected from a shaft portion;

FIG. 3A is a cross-sectional view of a release button according to an embodiment of the present invention as incorporated into a vehicle component;

FIG. 3B is a cross-sectional view of the release button of FIG. 3A showing a trim cover coupled to the release button;

FIG. 3C is a cross-sectional view of the release button of FIG. 3A shown in an actuated position and engaged with a lock mechanism;

FIG. 4A is a top perspective view of the release button of FIG. 2B positioned for engagement with a trim cover;

FIG. 4B is a top perspective view of the release button of FIG. 2A aligned for engagement with a trim cover; and

FIG. 4C is a top perspective view of a release button coupled to a vehicle component.

### DETAILED DESCRIPTION OF THE PREFERRED EMBODIMENTS

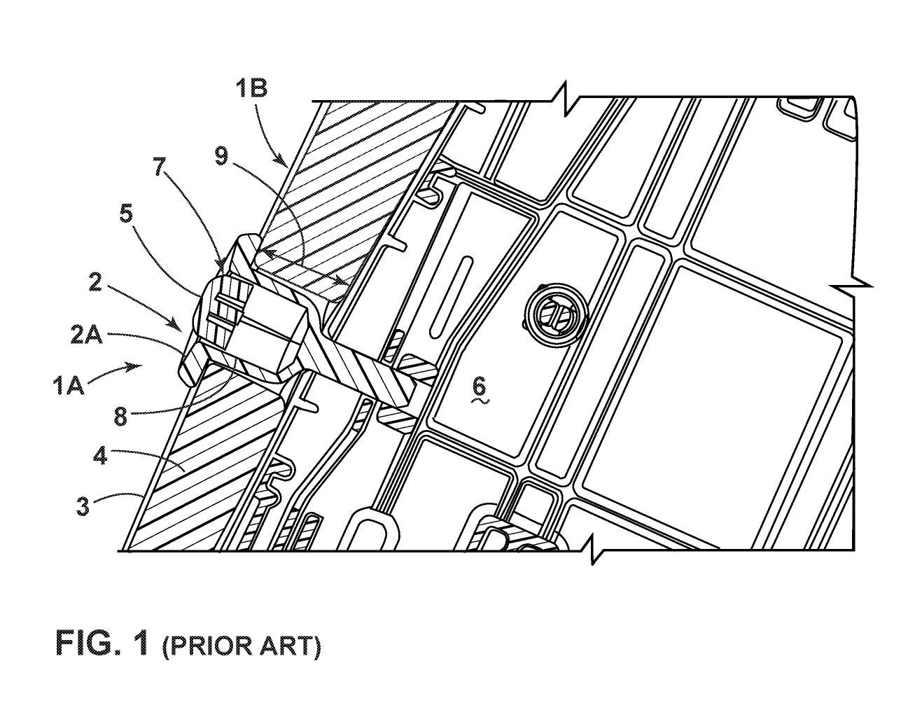

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, a release button assembly 1A is shown incorporated into a vehicle component 1B. The release button assembly 1A includes a bezel assembly 2 disposed through a cushion member 4, which is covered by a trim cover 3. The trim cover 3 is disposed under a lip 2A of the bezel assembly 2 to provide a finished look for the release button assembly 1A. The release button assembly 1A further includes a release button 5 that is moveable within a cavity portion 8 of the bezel assembly 2 along the path as indicated by arrow 9. In the embodiment shown in FIG. 1, the release button assembly 1A is configured to move inwardly to release a lock mechanism (not shown) disposed within an interior space 6 of the vehicle component 1B. With the bezel assembly 2 having a stationary lip 2A surrounding the release button 5, a potential pinch point exists, along with a potential source of vibration or rattle at the location identified by arrow 7 between the release button 5 and the stationary bezel assembly 2. The present concept is configured to provide a solution to the issues presented by the release button assembly 1A of the prior art shown in FIG. 1.

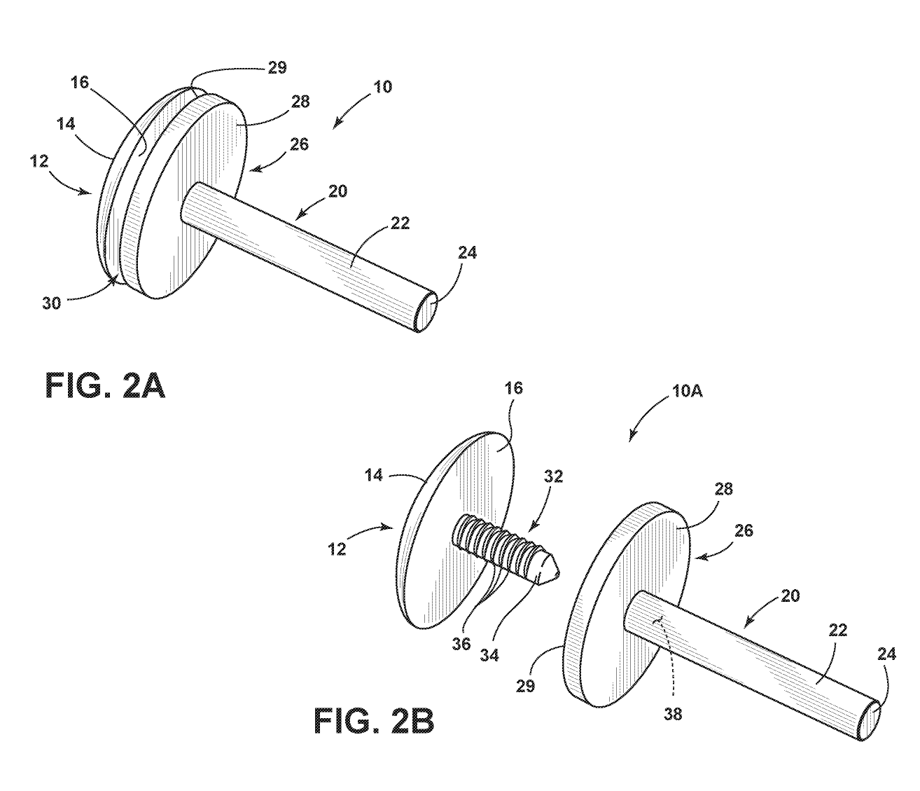

Referring now to FIG. 2A, an actuator button 10 is shown which may be referred to throughout this disclosure as a “button” or a “release button.” The actuator button 10 includes a head member 12 having first and second surfaces 14, 16. The first surface 14 is an outer surface that is configured for engagement by a user in moving the actuator button 10 between at-rest and actuated positions, as further described below. The second surface 16 of the head member 12 is an undersurface for the head member 12 and is shown in the embodiment of FIG. 2A as a substantially planar surface as compared to the outwardly rounded first surface 14. In the embodiment shown in FIG. 2A, the actuator button 10 further includes a shaft portion 20 having a body portion 22 which may be in the form of a cylinder having a distal end 24. A plate member 26 is disposed on the shaft portion 20 and outwardly extends from the body portion 22 of the shaft portion 20. The plate member 26 includes inner and outer surfaces 28, 29. As generally shown in FIG. 2A, the plate member 26 is spaced-apart from the head member 12 to define a receiving channel 30 therebetween. The receiving channel 30 is specifically defined between the second surface 16 of the head member 12 and the outer surface 29 of the plate member 26. The receiving channel 30 is configured to receive a portion of a trim cover therein to couple the actuator button 10 to a trim cover of a vehicle component, as further described below.

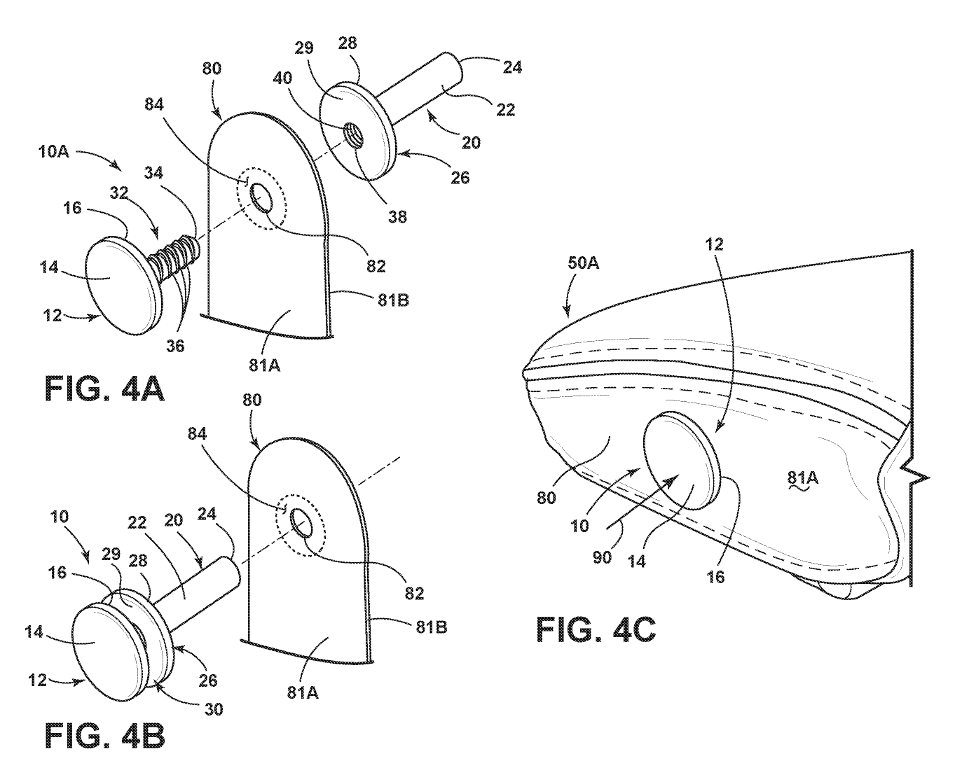

Referring now to FIG. 2B, another embodiment of an actuator button 10A is shown having similar features found in the actuator button 10 described above with reference to FIG. 2A, for which like reference numerals will be used. In the embodiment shown in FIG. 2B, the actuator button 10A is a two-part actuator button having the head member 12 that is separable from the shaft portion 20. Specifically, the head member 12 shown in FIG. 2B includes a threaded member 32 outwardly extending from the second surface 16 of the head member 12. Specifically, the threaded member 32 includes a shaft portion 34 having one or more engagement features 36 shown in the form of threads disposed therealong. For coupling the head member 12 to the shaft portion 20, the body portion 22 of the shaft portion 20 includes a hollow interior portion 38 that is contemplated to be internally threaded as best shown in FIG. 4A with one or more engagement features 40 shown in the form of internal threads disposed within the hollow interior portion 38. The internally threaded hollow interior portion 38 of the shaft portion 20 is configured to threadingly receive the threaded member 32 of the head member 12 when the head member 12 and the shaft portion 20 are in a coupled condition. In the coupled condition, the actuator button 10A has a configuration similar to the actuator button 10 shown in FIG. 2A. Thus, it is contemplated that the present concept may include a unitary single-piece actuator button, such as actuator button 10 shown in FIG. 2A, or be a multi-part assembly, such as actuator button 10A shown in FIG. 2B. While the actuator button 10A shown in FIG. 2B includes a threading engagement between the head member 12 and the shaft portion 20, it is contemplated that any engagement feature of the head member may engage a reciprocal or corresponding engagement feature of the shaft portion 20 to releasably couple the head member 12 to the shaft portion 20. For instance, clip assemblies may be used to interconnect the head member 12 with the shaft portion 20, or the shaft portion 20 may include an outwardly extending threaded member while the head member 12 includes an internally threaded hollow portion configured to receive the threaded member of the shaft portion 20 in a generally reverse configuration as compared to the configuration shown in FIG. 2B.

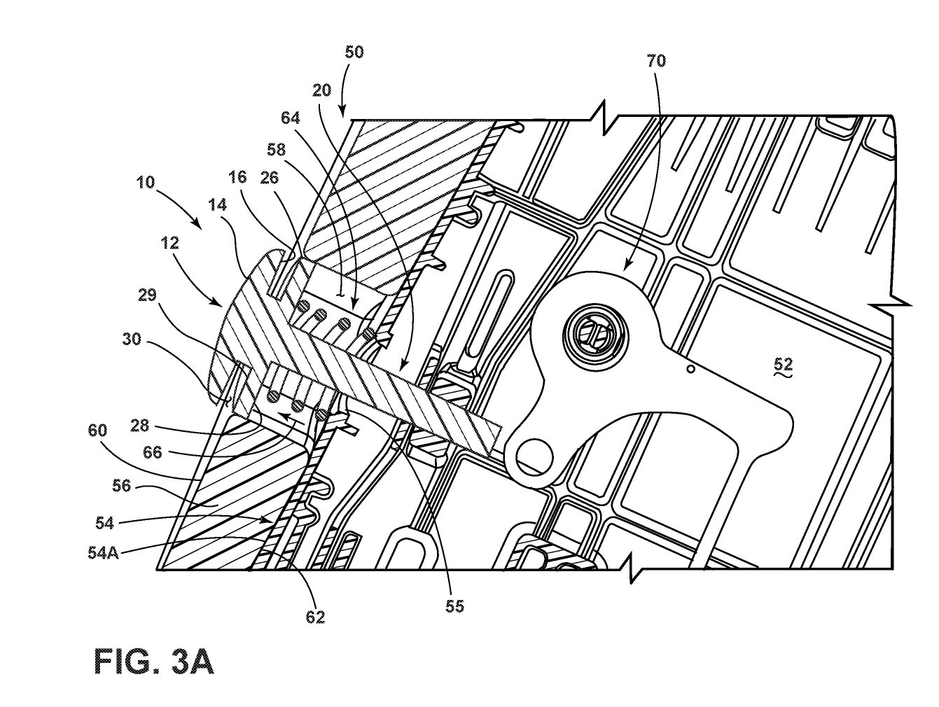

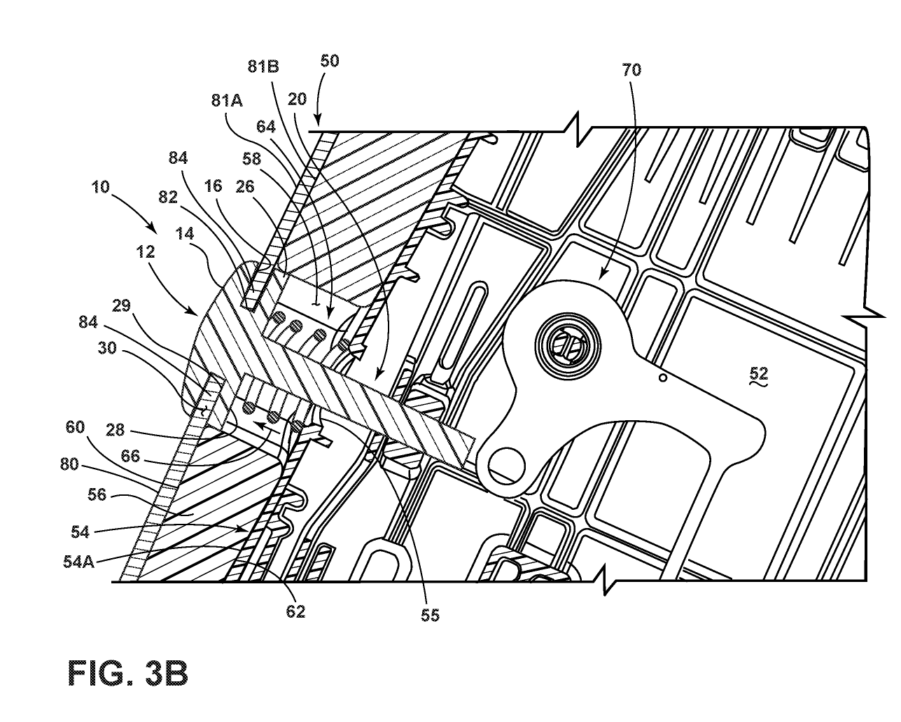

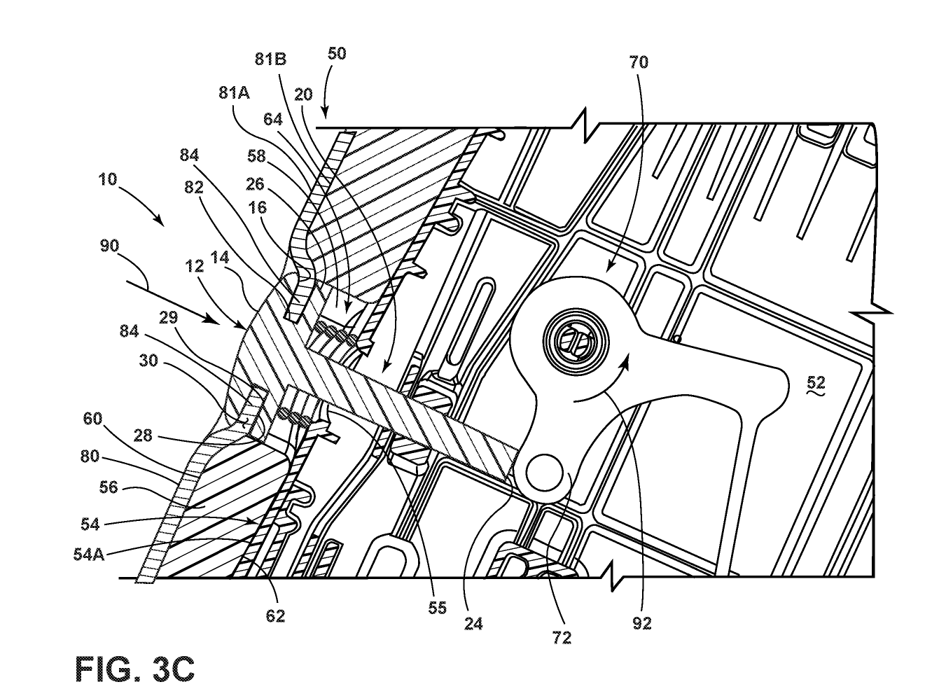

Referring now to FIG. 3A, a vehicle component 50 is shown having actuator button 10 incorporated into the vehicle component 50. It is contemplated that the vehicle component 50 may be an arm rest, a console assembly, a headrest assembly, or other component generally disposed within a vehicle interior. The vehicle component 50 shown in FIG. 3A includes an interior cavity 52 that is generally defined by a trim article 54. The trim article 54 surrounds the interior cavity 52 and may include a cushion member 56 disposed on or otherwise covering the trim article 54 to provide a padded vehicle component 50. The vehicle component 50 may include the trim article 54 alone, or the trim article 54 covered with a cushion member 56. The vehicle component 50 may also include a soft trim cover covering the cushion member 56 as further described below with reference to FIGS. 3B and 3C. In the embodiment shown in FIG. 3A, the cushion member 56 includes a receiving well 58 that is disposed through the cushion member 56 from an outer surface 60 to an inner surface 62 of the cushion member 56. The receiving well 58 may be a cylinder-shaped receiving well that opens into the interior cavity 52 of the vehicle component 50 and has a diameter that generally corresponds to the diameter of the head member 12 and plate member 26 of the actuator button 10. In the embodiment shown in FIG. 3A, the trim article 54 also includes an access aperture 55 therethrough, which is aligned with the receiving well 58 of the cushion member 56. In this way, the shaft portion 20 of the actuator button 10 can extend through the receiving well 58 of the cushion member 56 and the access aperture 55 of the trim article 54, such that the shaft portion 20 extends into the interior cavity 52 of the vehicle component 50. The vehicle component 50 further includes a lock mechanism 70 which is disposed within the interior cavity 52 and moveable between locked and released positions. In FIG. 3A, the lock mechanism 70 is shown in a locked position. The lock mechanism 70 is configured to retain an article in a locked configuration, and allow movement of the same article when the lock mechanism 70 is in the released position. The lock mechanism 70 moves to the release position by actuation of the actuator button 10 by a user from an exterior side of the vehicle component 50, as further described below. As such, the actuator button 10 is exposed on a first side thereof on an exterior of the vehicle component 50, and also is disposed within the interior space 52 of the vehicle component 50 on a second side thereof.

As further shown in FIG. 3A, the head member 12 of the release button 10 is shown extending outwardly from the cushion member 56, such that the receiving channel 30 is exposed and accessible outside of the vehicle component. In the configuration shown in FIG. 3A, the plate member 26 is shown received in the receiving well 58 of the cushion member 56. A biasing mechanism 64 is shown disposed around the shaft portion 20 of the actuator button 10 and abuts an upper surface 54A of the trim article 54 around the access aperture 55 of the trim article 54. At an opposite end, the biasing mechanism 64 abuts the inner surface 28 of the plate member 26 extending outwardly from the shaft portion 20 of the actuator button 10. In this way, the biasing mechanism 64 is configured to bias the actuator button 10 in an outward direction as indicated by arrow 66 to the at-rest position shown in FIG. 3A. In actuating the actuator button 10, a user will press on the head member 12 at the first surface 14 thereof to push the actuator button 10 inwardly into the vehicle component 50 against the force of the biasing mechanism 64. In FIG. 3A, the biasing mechanism 64 is shown in the form of a coil spring, but other biasing mechanisms are also contemplated for use with the present concept. When the actuator button 10 is released by a user, the biasing mechanism 64 will resiliently spring the actuator button 10 back to the at-rest position from the actuated position in the direction as indicated by arrow 66. In this way, the actuator button 10 is biased towards the at-rest position at all times to provide a clean aesthetic for the actuator button 10 as incorporated into the vehicle component 50.

Referring now to FIG. 3B, a trim cover 80 is shown covering the vehicle component 50, and is specifically disposed along the outer surface 60 of the cushion member 56. The trim cover 80 includes outer and inner surfaces 81A, 81B, as well as an access aperture 82 through which the actuator button 10 is received. In the configuration shown in FIG. 3B, a portion 84 of the trim cover 80 that surrounds the access aperture 82 is captured in the receiving channel 30 of the actuator button 10. When the portion 84 of the trim cover 80 is received in the receiving channel 30 of the actuator button 10, the portion 84 of the trim cover 80 is specifically captured between the second surface 16 of the head member 12 and the outer surface 29 of the plate member 26 of the actuator button 10. Thus, the head member 12 abuts the outer surface 81A of the soft trim cover 80 at second surface 16 thereof. In this way, the head member 12 provides a clean aesthetic for the vehicle component 50 by coupling to the trim cover 80 in a concealed manner under the first surface 14 of the head member 12. As noted above, the actuator button 10 of the present concept is configured to operate without a stationary bezel assembly to reduce the chances of vibration or rattle between components, and also to eliminate a potential pinch point between a stationary bezel assembly (found in the prior art) and a moving actuator button. The actuator button 10 of the present concept is configured to move while coupled to the trim cover 80 between at-rest and actuated positions to move or convert the lock mechanism 70 positioned within the interior cavity 52 of the vehicle component 50. In FIG. 3B, the actuator button 10 is shown in the at-rest position as biased thereto by the biasing mechanism 64. It is further contemplated that the actuator button 10 may include barbs, or other like retaining features, used to grip and engage the portion 84 of the trim cover 80 received in the receiving recess 30. The barbs may be disposed on either the second surface 16 of the head member 12 or the outer surface 29 of the plate member 26, or both. Further, an adhesive may be used in the receiving recess to retain the portion 84 of the trim cover 80 in the receiving recess 30.

Referring now to FIG. 3C, the actuator button 10 is shown in an inwardly pressed actuated position. In the inwardly pressed actuated position, it is contemplated that a user has contacted the first surface 14 of the head member 12 to press the actuator button 10 inwardly in a direction as indicated by arrow 90. Thus, the actuator button 10 moves from the at-rest position, shown in FIG. 3B, to the inwardly pressed actuated position, shown in FIG. 3C, in the direction as indicated by arrow 90 relative to the receiving well 58 of the cushion member 56. In the inwardly pressed actuated position, the shaft portion 20 of the actuator button 10 contacts the lock mechanism 70 to convert the lock mechanism 70 from the locked position to a released position. Specifically, in the embodiment shown in FIG. 3C, the distal end 24 of the shaft portion 20 contacts an engagement member 72 of the lock mechanism 70 to rotate the lock mechanism 70 in a direction as indicated by arrow 92. Thus, the lock mechanism 70 has moved from the locked position, shown in FIG. 3A, to the released position, shown in FIG. 3C, by a rotating movement in the direction as indicated by arrow 92 by the interaction of shaft portion 20 of the actuator button with the engagement member 72 of the lock mechanism 70. With the actuator button 10 in the inwardly pressed actuated position, it is contemplated that a component of the vehicle component 50 can be moved as released by the lock mechanism 70. Further, it is contemplated that the vehicle component 50 itself can be repositioned when the lock mechanism 70 is in the released position. As further shown in FIG. 3C, the biasing mechanism 64 is shown in a loaded position, wherein the biasing mechanism 64 is prepared to impart a force on the underside or inner surface 28 of the plate member 26 to return the actuator button 10 to the at-rest position as shown in FIG. 3B when the actuator button 10 is released by a user.

As further shown in FIG. 3C, the portion 84 of the trim cover 80 coupled to the actuator button 10 is shown as remaining in contact and coupled to the actuator button 10 even as the actuator button 10 moves from the at-rest position to the inwardly pressed actuated position. In this way, the present concept provides for an actuator button 10 that has a clean aesthetic and finished look without the need for a stationary bezel assembly to couple to and provide a finished appearance for the trim cover 80.

Referring now to FIG. 4A, the actuator button 10A is shown in a separated condition, wherein the head member 12 is separated from the shaft portion 20. In assembling the actuator button 10A, it is contemplated that the actuator button 10A may be in the separated condition shown in FIG. 4A for coupling the actuator button 10A to the trim cover 80. In coupling the trim cover 80 to this embodiment of the actuator button 10A, the threaded member 32 of the head member 12 will be inserted through the access aperture 82 of the trim cover 80, such that the threaded member 32 of the head member 12 can be threadingly received within the threaded hollow interior portion 38 to engage the engagement features 40 or threads disposed therein. In this way, the head member 12 can couple to the shaft portion 20 to define the receiving channel 30 between the head member 12 and the plate member 26 of the shaft portion 20 in which the portion 84 of the trim cover 80 is captured and received when the head member 12 and shaft portion 20 are in the coupled condition.

Further, it is contemplated that the actuator button 10 can be a unitary single-piece actuator button, such as shown in FIG. 4B. In this embodiment, the actuator button 10 is coupled to the trim cover by inserting the shaft portion 20 through the access aperture 82 of the trim cover 80 and then stretching the access aperture 82 of the trim cover 80 over the plate member 26 of the shaft portion 20. By stretching the access aperture 82 over the plate member 26, the portion 84 of the trim cover 80 can be received in the receiving channel 30 defined between the head member 12 and the plate member 26 of the actuator button 10. Thus, it is contemplated that the trim cover 80 can be a somewhat flexibly resilient cover in order to stretch over the plate member 26 and remain coupled and received within the receiving channel 30 of the actuator button 10 in assembly.

Referring now to FIG. 4C, the actuator button 10 is shown coupled to a vehicle component 50A, wherein the vehicle component 50A is shown in the form of a headrest assembly. The actuator button 10 is shown with the head member 12 having the second surface 16 thereof abutting the outer surface 81A of the trim cover 80. In FIG. 4C, the actuator button 10 is shown in the at-rest position, but is contemplated to move to the inwardly pressed actuated position by a user inwardly pressing the outer surface 14 of the head member 12 in an inward direction as indicated by arrow 90 to release a lock mechanism disposed within an interior cavity of the vehicle component 50A. With the actuator button 10 in the inwardly pressed actuated position, it is contemplated that the shaft portion 20 of the actuator button 10 will contact a lock mechanism, such as lock mechanism 70 shown in FIGS. 3A-3C, to release the lock mechanism, thereby allowing for movement of the vehicle component 50A. In the embodiment shown in FIG. 4C, it is contemplated that the actuator button 10 can be inwardly pressed to provide a folding movement for the headrest assembly 50A when the lock mechanism disposed therein is moved to a released position from a locked position by the actuation of the actuator button 10.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. An actuator button, comprising:
a head member having first and second surfaces;
a shaft portion extending outwardly from the second surface;
a plate member disposed on the shaft portion having inner and outer surfaces; and
a receiving channel defined between the second surface of the head member and the outer surface of the plate member.

2. The actuator button of claim 1, wherein the shaft portion includes an internally threaded hollow interior portion.

3. The actuator button of claim 2, including:
a threaded member outwardly extending from the second surface of the head member, wherein the threaded member of the head member is threadingly received in the internally threaded hollow interior portion of the shaft portion when the head member and the shaft portion are in a coupled condition.

4. The actuator button of claim 3, including:
a trim cover having a portion thereof received in the receiving channel, when the head member and the shaft portion are in the coupled condition.

5. The actuator button of claim 1, wherein the head member includes an engagement feature.

6. The actuator button of claim 5, wherein the shaft portion includes an engagement feature that is a reciprocal engagement feature to the engagement feature of the head member and configured to releasably couple with the engagement feature of the head member when the head member and the shaft portion are in a coupled condition.

7. The actuator button of claim 6, including:
a trim cover, wherein a portion of the trim cover is captured between the second surface of the head member and the outer surface of the plate member when the head member and the shaft portion are in the coupled condition.

8. The actuator button of claim 1, including:
a trim cover having a portion thereof coupled between the head member and the plate member.

9. A vehicle component, comprising:
a cushion member having a receiving well disposed therethrough;
a trim cover covering the cushion member and having an access aperture aligned with the receiving well of the cushion member; and
an actuator button coupled to the trim cover, wherein the actuator button includes a head member abutting an outer surface of the trim cover and a shaft portion extending into the receiving well of the cushion member.

10. The vehicle component of claim 9, wherein the shaft portion of the actuator button extends through the access aperture of the trim cover.

11. The vehicle component of claim 10, including:
a plate member disposed on the shaft portion.

12. The vehicle component of claim 11, including:
a receiving channel defined between an inner surface of the head member and an outer surface of the plate member.

13. The vehicle component of claim 12, wherein a portion of the trim cover surrounding the access aperture is received in the receiving channel of the actuator button.

14. The vehicle component of claim 9, wherein the actuator button is operable between at-rest and actuated positions relative to the receiving well.

15. The vehicle component of claim 9, including:
a lock mechanism disposed within an interior cavity of the vehicle component that is covered by the cushion member, wherein the lock mechanism is operable between locked and released conditions.

16. The vehicle component of claim 15, wherein the shaft portion of the actuator button extends through the receiving well into the interior cavity of the vehicle component, and further wherein the shaft portion contacts the lock mechanism when the actuator button moves from an at-rest position to an actuated position to convert the lock mechanism between the locked and released positions.

17. A vehicle component, comprising:
a trim article covered by a trim cover and having an access aperture opening into an interior cavity of the vehicle component covered by the trim article; and
an actuator button having a head member and a shaft portion extending outwardly from the head member through the access aperture of the trim article into the interior cavity of the vehicle component, wherein a portion of the trim cover is coupled to a receiving channel defined between the head member and a plate member disposed on the shaft portion of the actuator button.

18. The vehicle component of claim 17, wherein the actuator button is operable between an at-rest position and an inwardly pressed actuated position, and further wherein the actuator button is biased towards the at-rest position.

19. The vehicle component of claim 18, including:
a lock mechanism disposed within the interior cavity of the vehicle component, wherein the lock mechanism is operable between locked and released conditions.

20. The vehicle component of claim 19, wherein the shaft portion of the actuator button engages the lock mechanism when the actuator button is in the inwardly pressed actuated position to move the lock mechanism to the released condition from the locked condition.
